(19) United States
(12) Patent Application Publication
(10) Pub. No.: US 2004/0108074 A1
(43) Pub. Date: Jun. 10, 2004

(54) Taping unit for carton taping machine

(76) Inventor: Antonio Marchetti, Milano (IT)

Correspondence Address: JACOBSON HOLMAN PLLC, 400 SEVENTH STREET N.W., SUITE 600, WASHINGTON, DC, 20004, US

(21) Appl. No.: 10/312,671

(22) PCT Filed: Jun. 13, 2001
(86) PCT No.: PCT/EP01/06753

(30) Foreign Application Priority Data
Jul. 6, 2000 (IT) M 12000A001526

(51) Int. Cl. B32B 31/00

(52) U.S. Cl. 156/468; 156/522

(57) ABSTRACT

A pair of lower leg skateboards for affixation to the shins of a wearer. Each has a rearwardly tapered conformable bed, a stabilizing hand grip, a hand brake, a pair of roller blocks, a pair of rearwardly projecting ankle extensions, and inwardly engaging abutments, all of which interact: (1) to ensure maximum comfort of the lower legs while providing seating for the upper legs and body; (2) to ensure a rearwardly positioned center of gravity for safety; (3) to enable a natural grasp and vantage of the hands and arms; and (4) to maintain alignment of the skateboards when deployed.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates to skateboards, and, more particularly, to skateboards of the type that are designed to be fastened to the lower legs of a user. The users posture determines whether such skateboards are in undeployed mode or deployed mode. The user, when standing with the wheels of the skateboards forwardly and freely directed, may walk about with minimal interference or discomfort from the skateboards. The user, when kneeling, with the wheels of the skateboards downwardly directed in contact with a ground surface, may maneuver, jump, spin or race about on the skateboards with ease. Experience with such skateboards has shown that improvements are desired for enhanced safety, comfort and efficacy.

### SUMMARY OF THE INVENTION

The primary object of the present invention is to provide a pair of skateboards which are to be fastened to the lower legs of a wearer and which are characterized by a rearwardly tapered conformable bed for the knees and shins, forward and rearward roller trucks and hangers attached to the underside of the bed, a pair of hand notches at the sides of the bed for controlling the stance of the arms and upper body, a pair of hand brakes in proximity to the hand notches, a pair of rearwardly positioned spaces through which the shoes or boots of the wearer may be comfortably positioned, a pair of rearwardly projecting ankle extensions for stabilizing the rollers when the user is standing, walking or running, and inwardly directed abutments for maintaining contiguous alignment of the skateboards and separation of contiguous wheels during use. These components interact: (1) to ensure maximum comfort of the lower legs while providing an optional position thereon for the upper legs and body; (2) to ensure a rearwardly positioned center of gravity for safety; (3) to enable a natural grasp and vantage of the hands and arms; and (4) to maintain coordination of the legs and upper body when leaning left or right to turn.

### BRIEF DESCRIPTION OF THE INVENTION

For a fuller understanding of the nature and objects of the present invention, reference is made to the following specification, which is to be taken with the accompanying drawings, wherein:

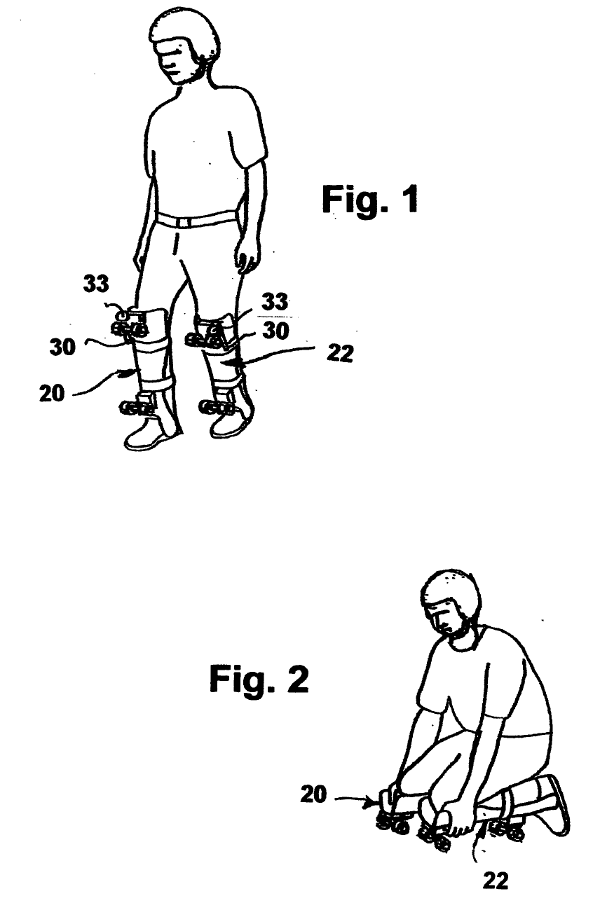

FIG. 1 shows a an upright person with a pair of the skateboards of the present invention fastened to his lower legs;

FIG. 2 shows a kneeling person with a pair of the skateboards referred to in FIG. 1 fastened to his lower legs in accordance with the present invention;

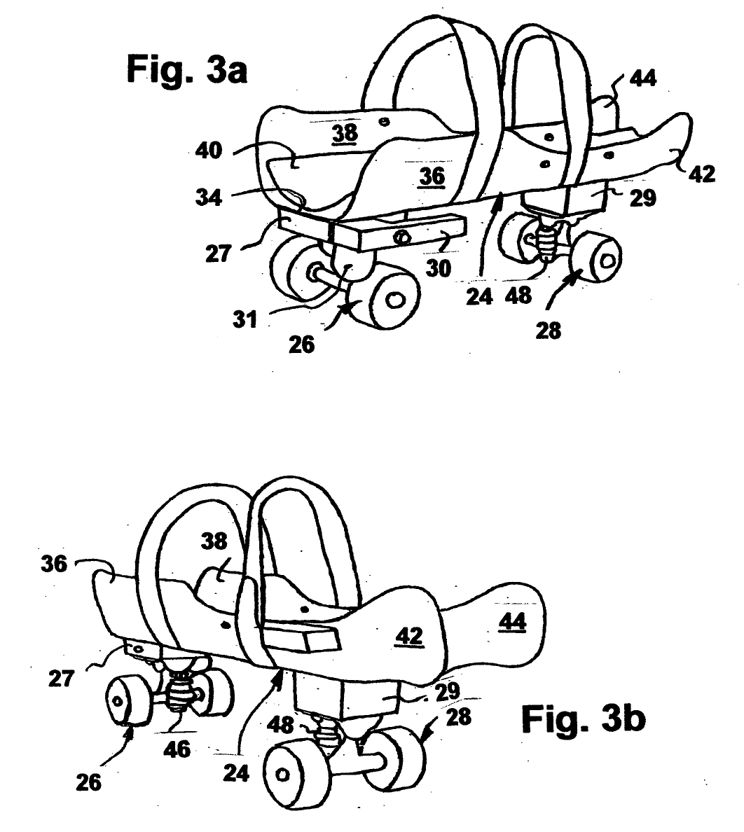

FIG. 3a is an anterior perspective view of one of a pair of skateboards that embody the present invention;

FIG. 3b is a posterior perspective view of the skateboard of FIG. 3a;

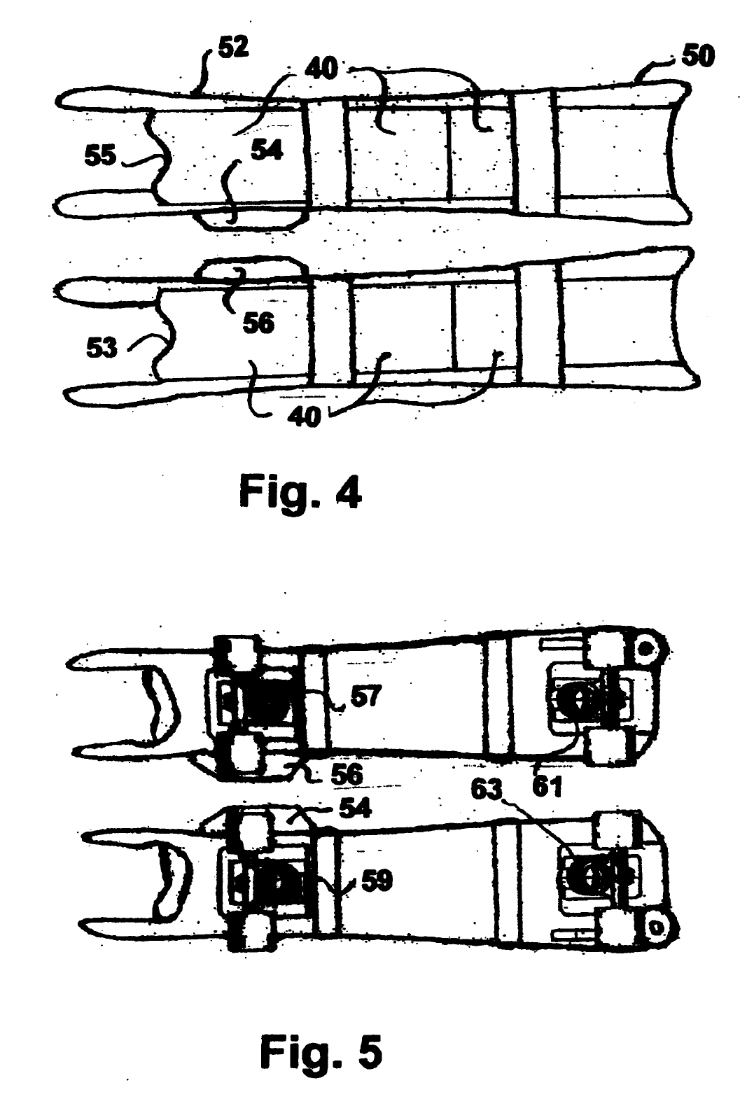

FIG. 4 is a top plan view of a pair of the skateboards of the present invention;

FIG. 5 is a bottom plan view of a pair of the skateboards of FIG. 4;

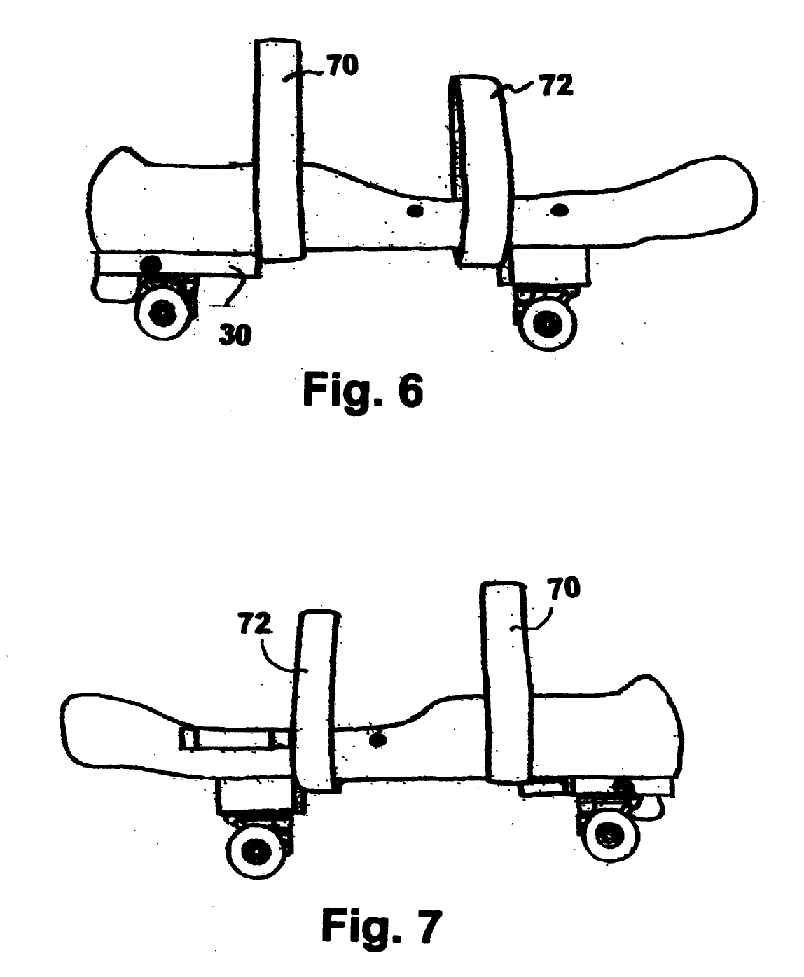

FIG. 6 is an outer side view of the left skateboard of FIG. 4, it being understood that the outer side view of the corresponding right skateboard is a mirror image of FIG. 6;

FIG. 7 is an inner side view of the left skateboard of FIG. 4, it being understood that the inner side view of the corresponding right skateboard is a mirror image of FIG. 7;

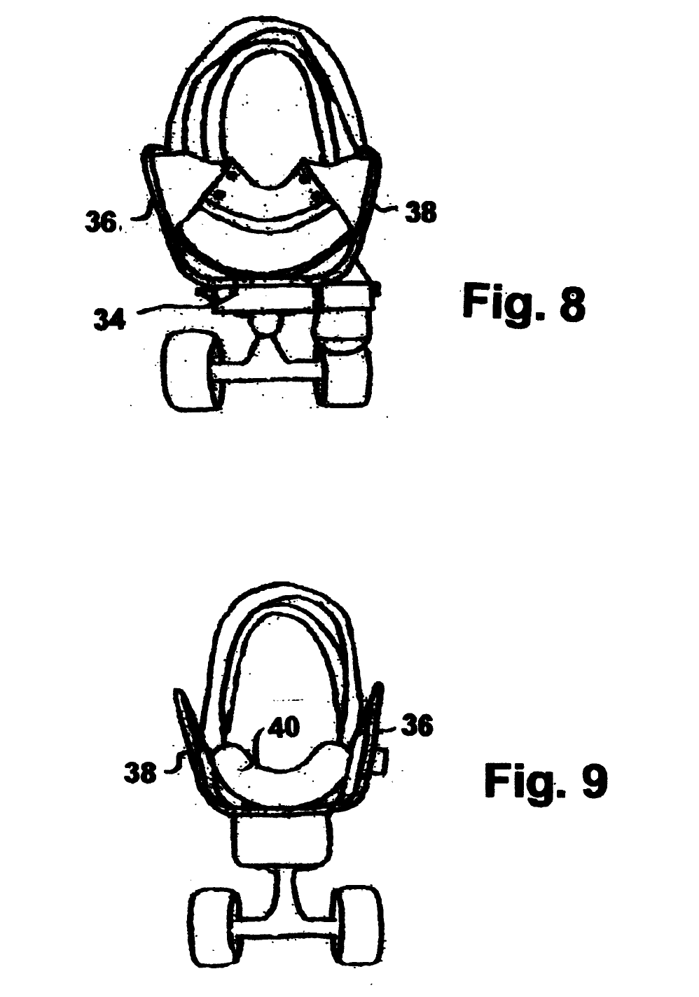

FIG. 8 is a front view of the left skateboard of FIG. 4, it being understood that the front view of the corresponding right skateboard is a mirror image of FIG. 8;

FIG. 9 is a back view of the left skateboard of FIG. 4, it being understood that the back view of the corresponding right skateboard is a mirror image of FIG. 9;

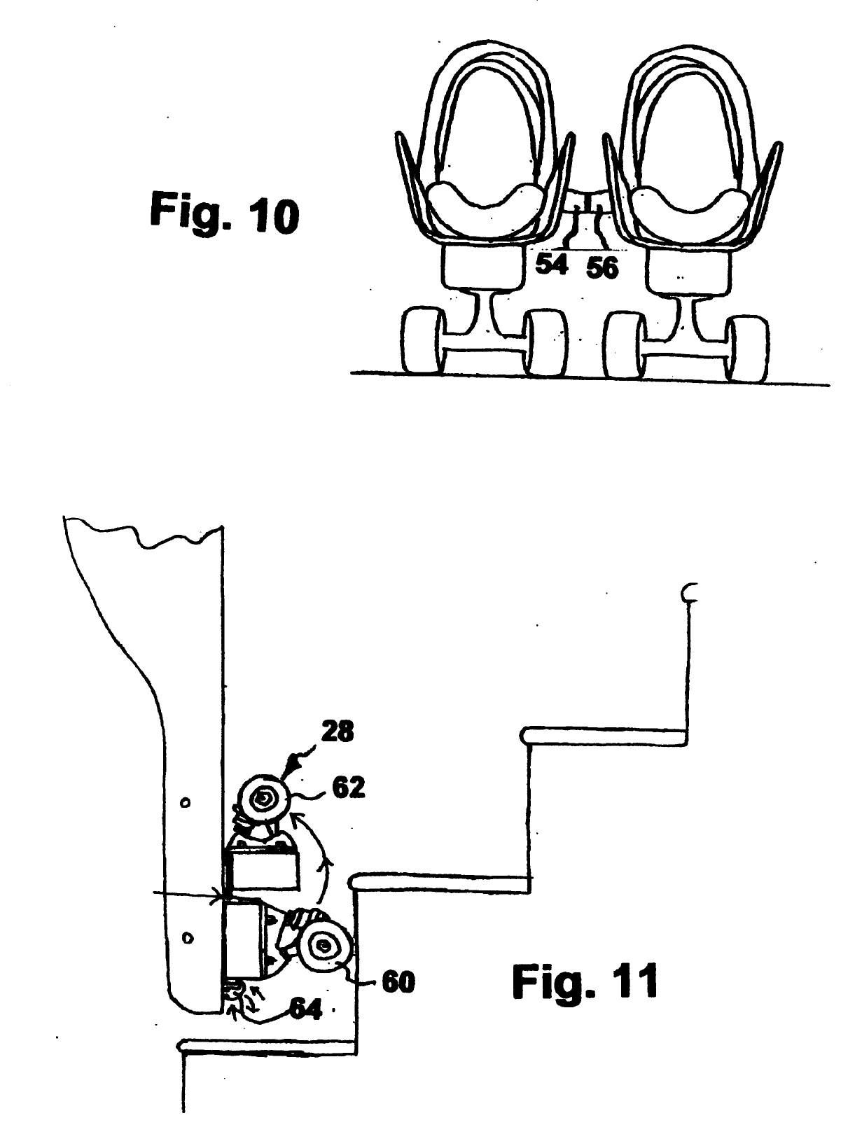

FIG. 10 is a rear view of a pair of the skateboards of the present invention, showing inwardly directed abutments in engagement; and

FIG. 11 is a side view of one of the skateboards of the present invention, showing the rear roller truck in deployed and undeployed positions.

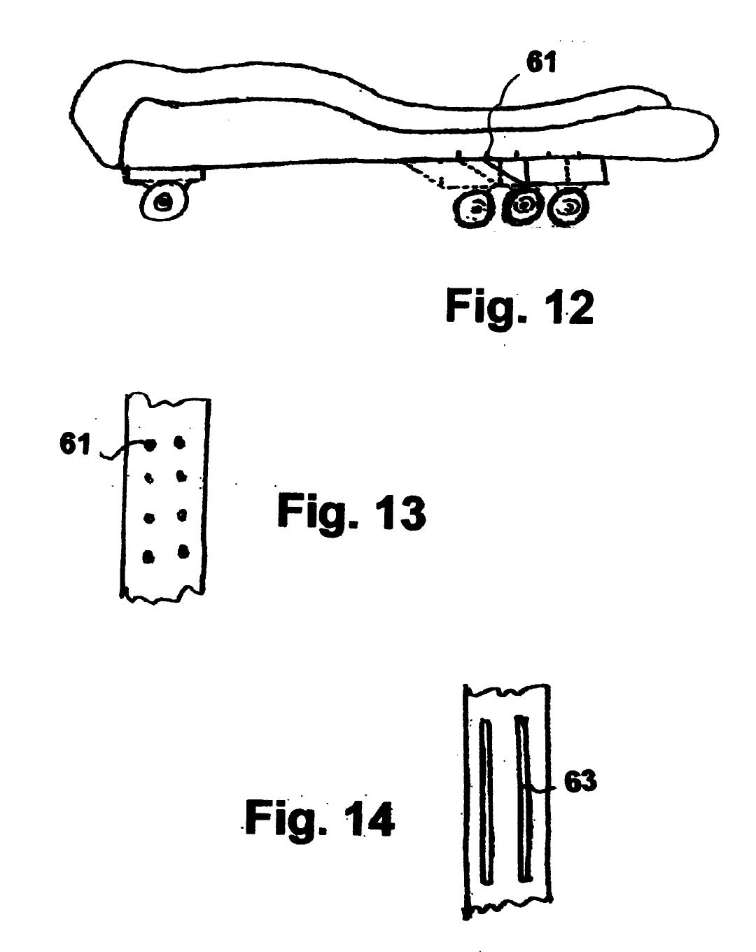

FIG. 12 is a perspective view of one of a pair of alternative skateboards that embody the present invention;

FIG. 13 is a fragmentary plan view of the underside of one of the bases of the skateboard of FIG. 12;

FIG. 14 is a fragmentary plan view of the underside of one the bases of an alternative version of the skateboard of FIG. 12;

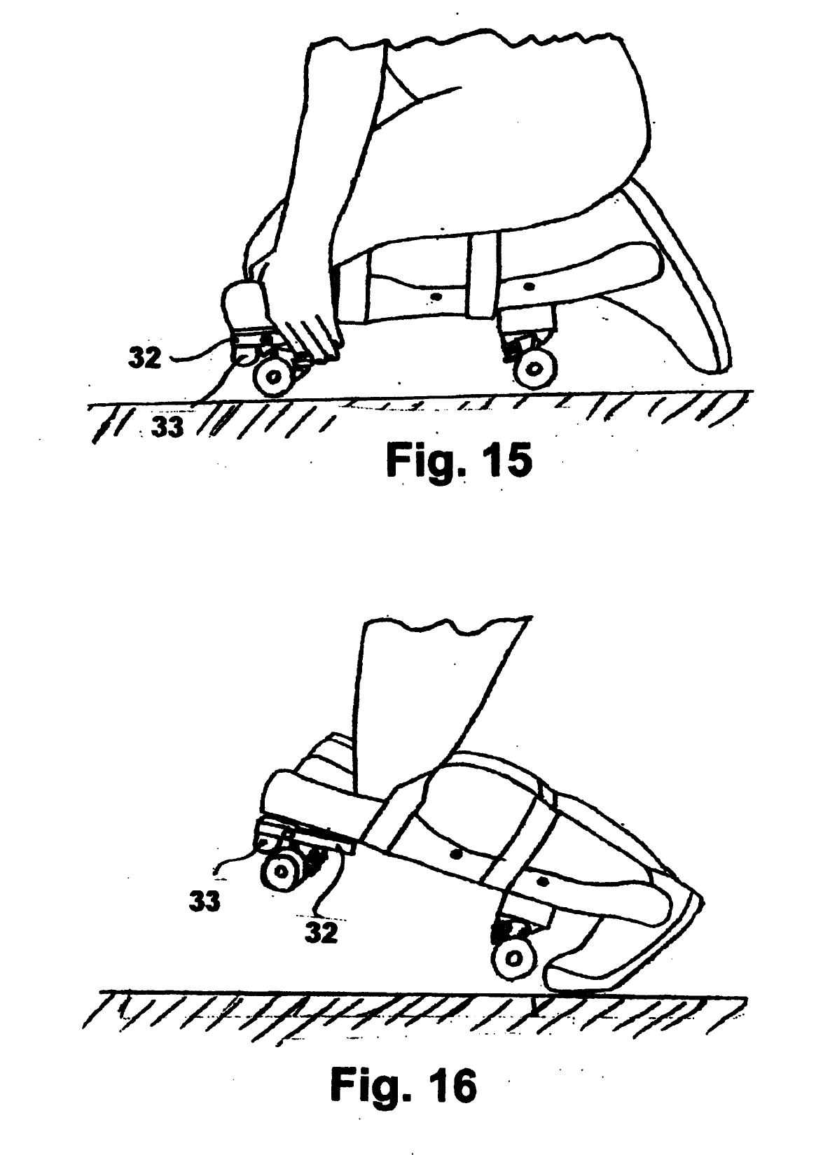

FIG. 15 is a side view of a skateboard of FIG. 1 showing the hand of the user gripping the notch section of the bed wall and the adjacent brake, and showing the foot displaced from the ground;

FIG. 16 is a side view of the skateboard of FIG. 1 showing a foot of the user freely touching the ground without interference from the rear wheels; and

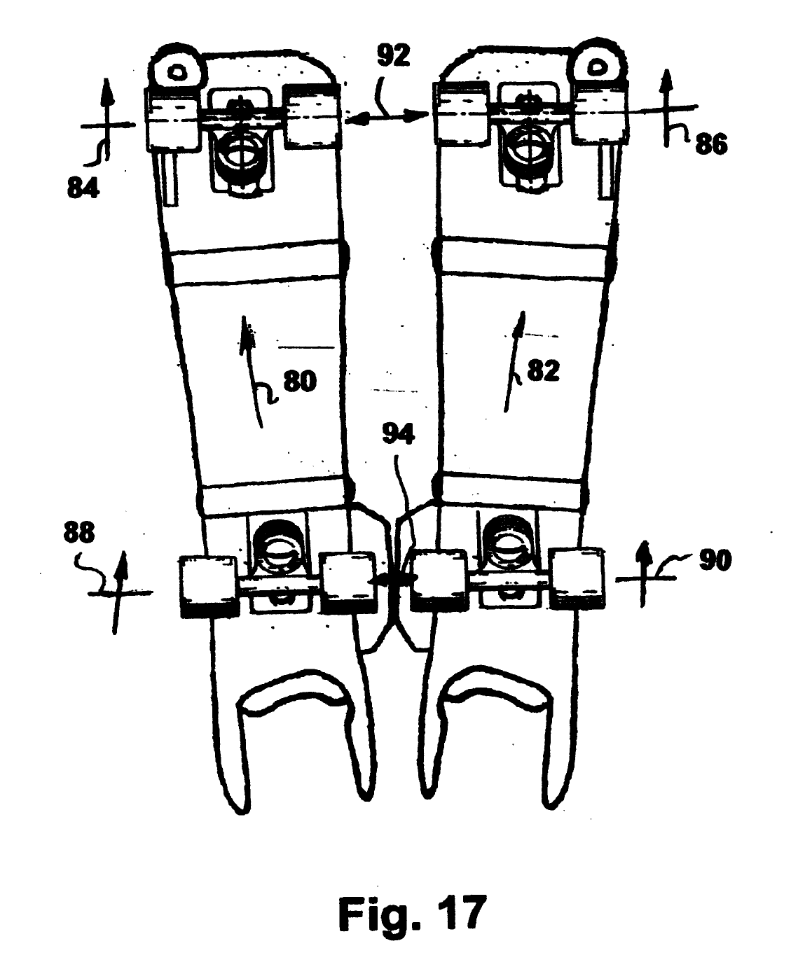

FIG. 17 shows the aligned orientations of the front and rear wheels of the skate boards during forward motion.

### DETAILED DESCRIPTION OF THE PREFERRED EMBODIMENT

The illustrated embodiment of the present invention is a pair of skateboards 20, 22, which may be fastened to the shins of the lower legs of a user as shown in FIGS. 1 and 2. These skateboards may be used in either a recreational or a work environment. As shown in FIG. 1, the user, when standing, may walk about with minimal interference by or discomfort from the skateboards. As shown in FIG. 2, the user, when kneeling, may maneuver or race about on the skateboards with ease.

As shown in FIGS. 3a and 3b, each of the skateboards comprises a body 24, a front roller truck 26, and a rear roller truck 28. Front roller truck 26 depends from and is affixed to a front roller block 27. Rear roller truck 28 depends from and is affixed to a rear roller block 29. A hand-activated control having hand actuated brake lever 30 (FIG. 6) is pivotally affixed to the forward sides of the front block. When gripped manually, a brake pad 33 abuts against an adjacent wheel to stop motion. Body 24, which is U-shaped in cross-section, has a base 34, a pair of opposed side walls 36, 38, and a pad 40. Pad 40 is composed of a compliant material, for example, an elastomeric foam of polyurethane or rubber. Pad 40 is nested in the body in contact with base 34 and side walls 36, 38. It is to be understood that the cross-section of body 24, in various embodiments, is composed of either a rounded horizontal base and upright walls or a flat horizontal base and orthogonal walls.

Roller truck 26 is trunnioned to the underside of roller block 27 by a swivel 46. Roller truck 28 is trunnioned to the underside of roller block 29 by a swivel 48. The wheels of roller truck 26 swivel clockwise and the wheels of roller truck 28 swivel counter-clockwise when body 24 is tilted to the right. The wheels of roller truck 26 swivel counter-clockwise and the wheels of roller truck 28 swivel clockwise when body 24 is tilted to the left. Rearward screws 57 and 59, and forward screws 61 and 63 may be turned to tighten or loosen the swiveling response. A tighter swivel enables stabilization at faster speeds. A looser swivel allows sharper turns at lower speeds. The rearward swivels preferably are tighter than the forward swivels for control and stabilization as a function of the weight of the user and the skateboard velocity.

Base 34, longitudinally, is sufficiently short to permit the knee to rest comfortably on pad 40 at the front extremity of the base, and the foot to depend freely beyond the pad at the rear extremity of the base. Side walls 36, 38 extend rearwardly beyond the rear end of base 34 to provide a pair of ankle stabilizers 42, 44 that are adapted to stabilize the skateboard body. Outer stabilizer 42 is smaller in transverse width than inner stabilizer 44 to accommodate greater projection of the outer ankle. Each of controls 30 is actuated when a user,s hand grips and squeezes the contoured upper edge of an outer wall of the skateboard body and the adjacent brake lever, in order to press the brake cushion against the contiguous wheel.

As shown in FIGS. 4 and 5, base 34 tapers inwardly from the front 50 to the rear 52 in order to snugly accommodate the taper of the users lower leg from its wider portion at the knee to its narrower portion at the ankle. As shown in FIG. 10, a pair of abutments 54, 56 extend toward each other from rearward portions of the inner walls of the left and right skateboards. As shown in FIGS. 5 and 10, the inner roller of the rearward roller truck lies within the horizontal profile of the abutment and the inner roller of the forward roller truck lies with the horizontal profile of the base of the body. The arrangement is such that parallelism of a pair of the skateboards is maintained by contact of their front body portions and contact of their rearward abutments during use. FIGS. 5 and 10 show abutments 54, 56, which keep the rear inside wheels from touching or binding each other. As shown in FIGS. 4 and 5, the base of each body has a cut away, off-center notch, shown at 53 and 55, which is positioned inwardly of the axis of the leg and is cut away as at 53 and 55 to accommodate the top of the each foot.

As shown in FIG. 11 in an alternative embodiment, the base of each rear roller truck 28 is pivotable between an active outer position 60 and an inactive inner position 62. At outer position 60, it is locked at 64 and available for active use. At inner position 62, it is stored to minimize any effect on the mobility of the wearer when climbing stairs as is suggested in FIG. 11.

The skateboards are fastened to the legs of a wearer by straps 70, 72 as shown in FIG. 6, at forward and reaward positions of the skateboard body. Each strap has two lengths, one anchored to one of the walls of the body and the other anchored to the other of the walls of the body. The free ends of the straps are mated, for example, by micro hook-and-loop pads (of the type sold under the trademark VELCRO), which mate when pressed together and separate when pulled apart. It is to be understood that, in alternative embodiments, the micro hook-and-loop pads are replaced by buckles or snaps.

The relationship between rear roller block 29 and front roller block 27 is to be noted. Block 29 is deeper in dimension than block 27 to ensure that the toes of the users shoes do not touch the ground.

In an alternative embodiment as shown in FIG. 12, the rear roller block may be fastened to the body at different positions shown in dashed lines, at which they may be secured by associated nuts and screws that project through holes 61 in the base of the body as in FIG. 12 or slots 63 in the base of the body as in FIG. 13. This configuration prevents the rear wheels from contacting the tips of the toes of users who have footwear of different sizes, as suggested in FIG. 16.

### OPERATION

In operation, the skateboards are fastened to the lower legs of a user by straps. The lower legs are nested in rearwardly tapered, U-cross section, conformable beds for the shins and knees. Rearwardly positioned spaces permit the shoes or boots of the user to project downwardly for comfort. The user, when standing with the wheels of the skateboards forwardly and freely directed, may walk about with minimal interference by or discomfort from the skateboards. The user, when kneeling with the wheels of the skateboards downwardly directed, may maneuver or race about on the skateboards with ease. Pairs of rearwardly projecting ankle extensions stabilize the skateboards during standing, walking or running. Inwardly directed abutments keep contiguous wheels from touching during use. This construction attempts to ensure comfort of the lower legs and aids in providing a comfortable position thereon for the upper legs and body, and maintains coordination of the legs by ensuring the parallelism of the skate boards.

Protruding peaks at the front top of each side wall 36, 38 provide a notch as suggested in FIG. 15. The outside notches are for the hands (specifically the area between the thumb and forefinger). The thumbs grasp the insides of the outer walls and the opposed fingers grasp the brake handles and the outsides of the outer walls. The extended peaks keep the hands from slipping forward and positioned over the brake handles. Also, the outside and inside peaks keep the body horizontal when the skateboards are overturned in parked condition on a bench, table or ground for repairs.

As shown in FIG. 17 in an alternative embodiment, the axes 80, 82 of the left and right skateboards, in use, diverge forwardly for user comfort. At the same time, the axes of all of the rollers, 84, 86, 88, 90, are parallel to each other so that the forward rollers are slightly more distant from each other, as at 92, than are the rearward rollers, as at 94. This configuration precludes unwanted divergence during forward movement of the skateboards.

What is claimed is:

1. A pair of skateboards to be fastened to the lower legs of a user, each skateboard of said pair comprising:
(a) a rearwardly tapered conformable bed for the knees and shins,
(b) forward and rearward roller blocks attached to the underside of said bed, forward and rearward roller carriages attached respectively to said roller blocks;
(c) said bed having hand-engaging portions for stabilizing the stance of the arms and upper body,
(d) a pair of rearwardly positioned spaces through which the footwear of the user may comfortably depend,
(e) a pair of rearwardly projecting ankle extensions for stabilizing said skateboards,
(f) the beds of said skateboards having inwardly directed abutments for maintaining contiguous alignment of the skateboards and separation of contiguous wheels during use,
(g) said user, with said skateboards deployed on the legs of said user by straps, being capable of walking when standing and maneuvering on said skateboards when kneeling.

2. A pair of skateboards to be fastened to the lower legs of a user, each skateboard of said pair comprising:
(a) a rearwardly tapered conformable bed for the shins;
(b) said bed being of U-shape cross-section and having a substantially horizontal base and a pair of substantially horizontal side walls;
(c) a pad nested within said bed;
(d) forward and rearward roller blocks attached to the underside of said bed, forward and rearward roller carriages attached respectively to said roller blocks;
(e) portions of the beds of said skateboards presenting stabilizing hand grips for controlling the stance of the arms and upper body;
(f) the bases of said beds having rearwardly positioned spaces through which the footwear of the user may project downwardly, while the shin rests on said pad;
(g) a pair of rearwardly projecting ankle extensions for stabilizing said skateboards;
(f) the beds of said skateboards having inwardly directed abutments for maintaining contiguous alignment and separation of contiguous wheels during use;
(g) said user, with said skateboards deployed on the legs of said user by straps, being capable of walking when standing and maneuvering on said skateboards when kneeling.

3. The pair of skateboards of claim 2 wherein said rollers of said forward roller carriage lie within the horizontal profile of said bed and said rollers of said rearward roller carriage extend outside said horizontal profile of said bed.

4. The pair of skateboards of claim 2 wherein said forward and rearward roller carriages of said one of said skateboards swivel in opposite directions when said bed of said one of said skateboards is tilted.

5. The pair of skateboards of claim 2 wherein the height of said side walls at the rear of said bed is less than the height of said side walls at the front of said bed.

6. The pair of skateboards of claim 2 wherein said inwardly directed abutments prevent contact of adjacent wheels of said pair of skateboards.

7. The pair of skateboards of claim 2 wherein said pad is composed of an elastomeric foam.

8. The pair of skateboards of claim 2 wherein each of said skateboards is adapted to be affixed to a lower leg of a user by a pair of straps, one of which is affixed to an upper section of the shin and the other of which is affixed to a lower section of the shin.

9. A pair of skateboards to be fastened to the lower legs of a user, each skateboard of said pair comprising:
(a) a rearwardly tapered conformable bed for the knees and shins,
(b) forward and rearward roller blocks attached to the underside of said bed, forward and rearward roller carriages attached respectively to said forward and rearward roller blocks;
(c) said bed having hand-engaging portions for stabilizing the stance of the arms and upper body,
(d) a pair of rearwardly positioned spaces through which the footwear of the user may comfortably depend,
(e) the beds of said skateboards having inwardly directed abutments for maintaining contiguous alignment of the skateboards and separation of contiguous wheels during use,
(f) said user, with said skateboards deployed on the legs of said user by straps, being capable of walking when standing and maneuvering on said skateboards when kneeling.

10. The pair of skateboards of claim 9 wherein said rollers of said forward roller carriage lie within the horizontal profile of said bed and said rollers of said rearward roller carriage extend outside said horizontal profile of said bed.

11. The pair of skateboards of claim 9 wherein said forward and rearward roller carriages of said one of said skateboards swivel in opposite directions when said bed of said one of said skateboards is tilted.

12. The pair of skateboards of claim 9 wherein the height of said side walls at the rear of said bed is less than the height of said side walls at the front of said bed.

13. The pair of skateboards of claim 9 wherein said inwardly directed abutments prevent contact of adjacent wheels of said pair of skateboards.

14. The pair of skateboards of claim 9 wherein said pad is composed of an elastomeric foam.

15. The pair of skateboards of claim 9 wherein each of said skateboards is adapted to be affixed to a lower leg of a user by a pair of straps, one of which is affixed to an upper section of the shin and the other of which is affixed to a lower section of the shin.

16. The pair of skateboards of claim 1 wherein the said skateboards, in use, diverge forwardly for user comfort and wherein the axes of all of the rollers are parallel to each other so that the forward rollers are slightly more distant from each other than are the rearward rollers, whereby unwanted divergence during forward movement of the skateboards is averted.

17. The pair of skateboards of claim 2 wherein said skateboards, in use, diverge forwardly for user comfort and wherein the axes of all of the rollers are parallel to each other so that the forward rollers are slightly more distant from each other than are the rearward rollers, whereby unwanted divergence during forward movement of the skateboards is averted.

18. The pair of skateboards of claim 9 wherein said skateboards, in use, diverge forwardly for user comfort and wherein the axes of all of the rollers are parallel to each other so that the forward rollers are slightly more distant from each other than are the rearward rollers, whereby unwanted divergence during forward movement of the skateboards is averted.
